(19) United States
(12) Patent Application Publication
(10) Pub. No.: US 2007/0255538 A1
(43) Pub. Date: Nov. 1, 2007

(54) Method of developing an analogical VLSI macro model in a global Arnoldi algorithm

(75) Inventors: Chia-Chi Chu, Tao-Yuan (TW); Ming-Hong Lai, Tao-Yuan (TW); Wu-Shiung Feng, Tao-Yuan (TW)

Correspondence Address: NIKOLAI & MERSEREAU, P.A., 900 SECOND AVENUE SOUTH, SUITE 820, MINNEAPOLIS, MN, 55402, US

(73) Assignee: CHANG GUNG UNIVERSITY, Tao-Yuan (TW)

(21) Appl. No.: 11/414,045

(22) Filed: Apr. 27, 2006

(51) Int. Cl. G06F 17/10

(52) U.S. Cl. 703/2

(57) ABSTRACT

A new method for MIMO RLCG interconnects model order reduction technique using the global Arnoldi algorithm is proposed that is an extension of the standard Arnoldi algorithm for MIMO systems. Under this framework, the input matrix serves as a stacked vector form and the global Arnoldi algorithm will be the standard Arnoldi algorithm applied to a new matrix pair. This new matrix Krylov subspace from the Frobenius orthonormalization process is the union of system moments. By employing the congruence transformation with this matrix Krylov subspace, the one-sided projection method can be used to construct a reduced-order system. Connections of the reduced system and the original RLCG interconnect circuits are developed. The transfer matrix residual error of reduced system is derived analytically. This error information will be a guideline for the order selection scheme. Experimental results demonstrate the feasibility and the effectiveness of the proposed method.

### BACKGROUND OF THE INVENTION

1. Field of the Invention

This invention relates to a method of developing an analogical VLSI macro model in a global Arnoldi algorithm and particularly to that of a fast and precise simplified design on an interconnect circuit model with multiple inputs and outputs.

2. Description of Related Art

From the development of CMOS process technology to that of Nano technology, the parasitic effect of an interconnection circuit cannot be ignored, such as IC Interconnect Analysis proposed by M. Celik, L. T. and A. Odabasioglu, Kluwer Academic Publishers in 2002, on the characteristics of interconnection circuit operation. The interconnect circuit is generally represented with mathematics models. Owing to the complexity of a circuit that is gradually going up, that of model order for precisely simulating the circuit also does; thus, a method of effectively reducing the model becomes an essential technology for interconnect circuit reduction and simulation, such as U.S. Pat. Nos. 6,810,506, 6,789,237, 6,687,658, 6,041,170, and U.S. Pat. No. 6,023,573, Krylov-Subspace Methods for Reduced-Order Modeling in Circuit Simulation, Journal of Computational and Applied Mathematics, Vol. 123, pp. 395-421, proposed by R. W. Freund in 2000; and On Projection Based Algorithm for Model Order Reduction of Interconnects, IEEE Trans. on Circuits and System-I: Fundamental Theory and Applications, Vol. 49, No. 11, pp. 1563-1585, proposed by J. M. Wang, C. C. Chu, Q. Yu and E. S. Khu in 2002.

In the design of high-speed VLSI, an interconnect circuit modeling technology is highly concerned, and several methods have recently been proposed to solve the problems. A prior art is, for example, Asymptotic Waveform Evaluation (AWE), and Arnoldi algorithm, “On Projection-Based Algorithms for Model-Order Reduction of Interconnects,” IEEE Trans. on Circuit and Systems-I: Fundamental Theory and Applications, Vol. 49, No. 11, pp. 1563-1585, proposed by J. M. Wang, C. C. Chu, Q. Yu and E. S. Kuh in 2002. Besides, “Error Estimations of Arnoldi-Based Interconnect Model-Order Reductions,” IEICE Trans. Fundamentals, Vol. E88-A, No. 2, pp. 533-537 was proposed by C. C. Chu, H. J. Lee and W. S. Feng in 2005.

PVL (Padé via Lanczos), “Efficient Linear Circuit Analysis by Padé Approximation via the Lanczos Process,” IEEE Trans. Comput-Aided Des. Integr. Circuits Syst., Vol. 15, No. 5, pp. 639-649, was proposed by P. Feldmann and R. W. Freund in 1995. Further, “Oblique Projection Methods for Large Scale Model Reduction, [symbol] ” SIAM J. Matrix Anal. Appl., Vol. 16, No. 2, pp. 602-627, was proposed by I. M. Jaimoukha and E. M. Kaseally in 1995. Next, “Krylov-subspace methods for reduced-order modeling in circuit simulation,” J. Comput. Appl. Math., vol. 123, pp. 395-421, was proposed by R. W. Freund in 2000.

However, the prior arts mentioned above only deals with the Signal Input Signal Output (SISO) system; they have not yet dealt with the Multiple Input Multiple Output (MIMO) system.

Additionally, among the prior arts, MPVL, Reduced-Order Modeling of Large Linear Subcircuits via a Block Lanczos Algorithm,” 32nd ACM/IEEE Design Automation Conference, pp. 474-479, was proposed by P. Feldmann and R. W. Freund.

Block Arnoldi (BA) algorithm, “Krylov subspace techniques for reduced-order modeling of large-scale dynamical systems,i” Appl. Numer. Math., vol. 43, no. 1-2, pp. 9-44, was proposed by Z. Bai in 2002. Next, Krylov space methods on state-space control models,” Circuits Syst. Signal Process., vol. 13, no. 6, pp. 733-758, was proposed by D. L. Boley in 1994. RIMA: Passive Reduced-Order Interconnect Macromodeling Algorithm,i” IEEE Trans. on Computer-Aided Design of Integrated Circuits and Systems, Vol. 17, No. 8, pp. 645-654, was proposed by A. Odabasioglu, M. Celik and L. T. Pileggi in 1998.

The MPVL and the block Arnoldi algorithm give the technology of MIMO system model reduction, but when the order of reduced system is higher, the value may not be stable yet.

The relationship between the reduced circuit and the original circuit is then observed. A transfer function in a frequency domain is generally used to determine whether operation characteristics are consistent. Residual errors of two transfer functions may be regarded as a guideline of the model reduction algorithm to stop iteration process. In the prior arts, Bai used the PVL algorithm to derive a transfer function error E(s) between an original circuit and a reduced circuit. (“Error bound for reduced system model by Pade approximation via the Lanczos process,” IEEE Trans. On Computer-Aided Design of Integrated Circuits and Systems, Vol. 18 pp. 133-141, was proposed by Z. Bai, R. D. Slone, W. T. Smith and Q. Ye in 1999.) However, the expression of error involves the complicated operation of a decomposed matrix (iₙ−sA)⁻¹ of the original circuit, which is thus not practical to LSI.

In another prior art, the decomposed matrix (iₙ−sA)⁻¹ is replaced with a decomposed matrix of reduced circuit, and the PRIMA algorithm is used to get the transfer function error (“Practical considerations for passive reduction of RLC circuits,” Proc. ICCAD, pp. 214-219, proposed by A. Odabasioglu, M. Celik, and L. T. Pileggi in 1999).

Next, in another prior art, in order to avoid the complicated operation of transfer function error E(s), a residual error Eᵣ(s) is given to replace the technology of transfer function E(s) (“Krylov Projection Methods for Model Reduction,” Ph.D. thesis, University of Illinois at Urbana-Champaign, Urbana, Ill., proposed by E. J. Grimme in 1997).

Consequently, because of the technical defects of described above, the applicant keeps on carving unflaggingly through wholehearted experience and research to develop the present invention, which can effectively improve the defects described above.

### SUMMARY OF THE INVENTION

This invention is to solve technical problems of prior arts, such as Asymptotic Waveform Evaluation, Arnoldi algorithm, PVL and so on, which only deal with a Signal Input Signal Output (SISO) system but not deal with a Multiple Input Multiple Output (MIMO) system. The MPVL and the block Arnoldi algorithm give the technology of MIMO system model reduction, but when the order of reduced system is higher, the value may not be stable yet.

For solution to the problems above, this invention provides a method of developing an analogical VLSI macro model in a global Arnoldi algorithm, comprising:

step 1 to input a net-shaped circuit;

step 2 to input a frequency expansion point;

step 3 to build up a state-space matrix for a circuit;

step 4 to generate a projection matrix by way of a global Arnoldi algorithm;

step 5 to determine a reduced model order by an iteration termination condition, and to execute a first model reduction; and

step 6 to build up a mathematics model for a perturbation system and to execute a second model reduction.

From the description above, under the iteration termination condition at step 5, the residual error for the first reduced system and the original system may be defined to be:
Eᵣ(s)=s(V_{g,q}V_{g,q}⁺−Iₙ)h_{q+1,q}^{g}V_{g,q+1}E_{q}^{T}(I_{qs}−s(H_{g,q} [symbol] Iₛ)−sV_{g,q}⁺ΔV_{g,q})
∥Eᵣ(s)∥_{∞}≦κ(S_{qs})∥V_{g,q}V_{g,q}⁺−Iₙ∥₂|h_{q+1,q}^{g}|∥V_{g,q}⁺∥ ∥R∥₂
may be given when a norm is derived from Eᵣ(s); a value in the iteration process h_{q+1,q}^{g} may technically serve to evaluate the reduced model order; thus, an order q is determined to satisfy

$${μ}_{q} = ‖ \frac{{h}_{q , q - 1}^{g}}{{h}_{q + 1 , q}^{g}} ‖ < ɛ ,$$

where ε is a permissible error that is small enough.

where for the second model reduction described at step 6, the perturbation system is added to serve as the perturbation of additive property for the transfer function H(s) of original circuit, and the transfer function H(s) of a corrective node analysis may be indicated below as:

$$A \frac{ⅆ {x}_{Δ} ( t )}{ⅆ t} = {x}_{Δ} ( t ) + R u ( t ) and y ( t ) = C {x}_{Δ} ( t )$$

where Δ=h_{q+1,q}^{g}V_{g,q+1}E_{q}^{T}V_{g,q} and q are reduced model orders in a global Arnoldi algorithm, h_{q+1,q}^{g} and V_{g,q+1} may be given in the process of operation of the reduction system, V_{g,q}⁺ is a virtual inverse matrix of a projection matrix V_{g,q}, and thus the transfer function H_{Δ}(s) of perturbation system is equal to a transfer function Ĥ(s) of the system that is reduced.

Compared with the prior arts for the effects, the global Arnoldi algorithm according to this invention may be regarded as an extension of conventional SISO Arnoldi algorithm. In the algorithm, Krylov subspace generated in Frobenius orthonormalization process should be used and is actually a transformation from a conventional method, in which an input matrix may be regarded as a stacked vector form, namely the union of original system moments. By employing the congruence transformation with the matrix Krylov subspace generated in the global Arnoldi algorithm according to this invention, the one-sided projection method can be used to construct a reduced model system; in comparison with the model reduction skill of the current block Arnoldi algorithm, it proves that the transfer functions of two reduced system are identical and the complicated calculation of global Arnoldi algorithm is easier than that of the conventional block Arnoldi algorithm. This invention provides a residual error relation for the reduced system and the original system and error formulae on which the order determination of reduced circuit is based. Further, in this invention, a math expression of the MIMO circuit perturbation system. It proves that the transfer matrix in a two-order reduced system is corresponding to the transfer function of the added perturbation matrix in the original system.

However, in the description mentioned above, only the preferred embodiments according to this invention are provided without limit to this invention and the characteristics of this invention; all those skilled in the art without exception should include the equivalent changes and modifications as falling within the true scope and spirit of the present invention.

### BRIEF DESCRIPTION OF THE DRAWINGS

FIG. 1 is a flow chart of this invention.

FIG. 2 is a schematic view illustrating an embodiment of test on an interconnection circuit with 2 inputs and 2 outputs.

FIG. 3 is a schematic view illustrating the number of order of a parameter-determined reduced model in the process of algorithm iteration according to this invention.

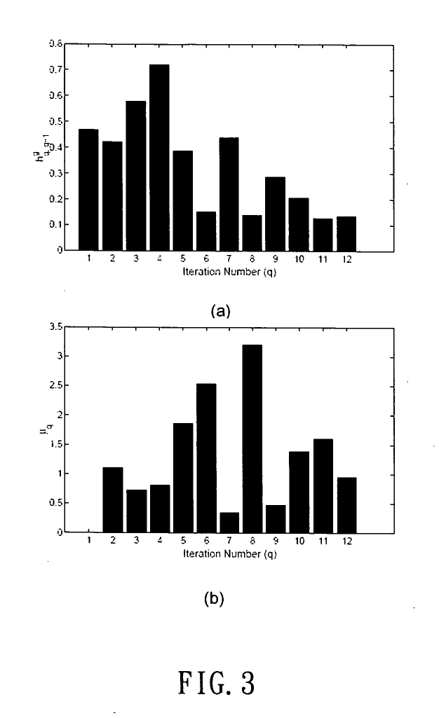

FIG. 4 is a schematic view illustrating an analysis on errors between the system union of three reduced models according to this invention and the system union of an original system.

FIG. 5 is a schematic view illustrating the frequency response of a first reduced model and a reduced model of block Arnoldi algorithm according to this invention.

FIG. 6 is a schematic view illustrating the frequency response of a second reduced model and an original system of added perturbation system according to this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

In a prior art, a linear, time-invariant, RLCG interconnect circuit in VLSI is generally represented in the following Modified Nodal Analysis (MNA) formula:

$$M \frac{ⅆ x ( t )}{ⅆ t} + N x ( t ) + B u ( t ) = 0 and y ( t ) = C x ( t ) . \qquad ( 1 )$$

where

$$M = [ \begin{matrix}C & 0 \\ 0 & L\end{matrix} ]$$

comprises a capacitor and an inductor, and

$$N = [ \begin{matrix}0 & E \\ - {E}^{T} & R\end{matrix} ]$$

comprises a resistor and satisfies the incidence matrix E in Kirchhoff's voltage and current laws. M, N ε R^{n×n} and B ε R^{n×s} represents nodes of voltage sources applied, in which s is the number of voltage sources. C ε R^{k×n} represents a node that measures impulse response, in which k represents a single measured point. x(t) represents a system union function, comprising voltage union and current union, namely

$$x ( t ) = [ \begin{matrix}v ( t ) \\ i ( t )\end{matrix} ] ,$$

while u(t) represents a function of system input signal. For A=−(N+s₀M)⁻¹M and R=(N+s₀M)⁻¹B, s₀ represents a frequency expansion point for selection, assuming that N+s₀M is a non-singular matrix. Then, equation (1) may be changed into

$$A \frac{ⅆ x ( t )}{ⅆ t} = x ( t ) + R u ( t ) and y ( t ) = C x ( t ) \qquad ( 2 )$$

The reduced model is used to find a smaller status space and provided for a designer to analyze the original system in limited hours through equivalent, original system. For the reduced system (MNA), equation (2) may be changed to:

$$\hat{A} \frac{ⅆ \hat{x} ( t )}{ⅆ t} = \hat{x} ( t ) + \hat{R} u ( t ) and y ( t ) = \hat{C} \hat{x} ( t ) \qquad ( 3 )$$

where for Â ε R^{q×q} and Â ε R^{q×q}, q represents the order of reduced system. This invention is briefly described for s=k.

For the MIMO system, a standard Arnoldi algorithm must be corrected. The BA algorithm is a known method of solving MIMO and generates an orthonormalization base κ_{b}(A,V_{b,0})={V_{b,0} AV_{b,0} . . . A^{q-1}V_{b,0}} in the Krylov subspace by means of recursion, and generates a projection matrix V_{b,q}=[V_{b,1} V_{b,2} . . . V_{b,q}]ε R^{n×qs} ε K_{b}(A,V_{b,1}), in which V_{b,1} is given from a matrix R through QR. The original system A in the MIMO system may be reduced to a smaller Upper Hessenberg Matrix. A pseudo code for the BA algorithm is shown below.

Algorithm : (input :A ,R,q; output:V_{q}^{b}, H_{q}^{b})
(1): /* Initialize */
Factor V₀R=QR factorization of R
V_{q}^{b} = [V₁]
(2): /* Iteration */
for K = 1,2,···,q

Vₖ⁽⁰⁾ = AVₖ₋₁
for j= 1,2,···,k

H_{k-j,k-1}^{b} = Vₖ₋ⱼ^{T}Vₖ^{(j-1)}
Vₖ^{(j)} = Vₖ^{(j-1)} − vₖ₋ⱼH_{k-j,k-1}^{b}

end for

Factor (V_{q}^{b})ₖ(H_{q}^{b})_{k,k-1} = QR factorization of Vₖ^{(k)}
end for

In the process of BA algorithm iteration, the relation is:
AV_{b,q}=V_{b,q}H_{b,q}+V_{b,q}h_{q,q-1}^{b}E_{q}^{T} (4)

where

$${E}_{q} = {[ \begin{matrix}{0}_{s} & ⋯ & {0}_{s} & {I}^{s \times s}\end{matrix} ]}^{T} ∈ {R}^{qs \times s} and$$

$${H}_{b , q} = [ \begin{matrix}{h}_{11}^{b} & {h}_{12}^{b} & ⋯ & ⋯ & {h}_{1 q}^{b} \\ {h}_{21}^{b} & {h}_{22}^{b} & ⋯ & ⋯ & {h}_{2 q}^{b} \\ 0 & {h}_{32}^{b} & {h}_{33}^{b} & ⋯ & ⋮ \\ ⋮ & ⋰ & ⋰ & ⋰ & ⋮ \\ 0 & ⋯ & 0 & {h}_{q , q - 1}^{b} & {h}_{q q}^{b}\end{matrix} ] ∈ {R}^{q s \times q s}$$

H_{b,q} is an upper Hessenberg matrix, and the relation between H_{b,q} and A is:
H_{b,q}=V_{b,q}^{T}AV_{b,q} (5)

where V_{b,q}^{T} V_{b,q}=I^{qs×qs}.

If A^{j-1} is multiplied at the left side of equation (4) and A^{j-1} is multiplied at the right side of equation (4), then
A^{j}V_{b,1}=V_{b,q}H_{b,q}^{j}E_{q}, ∀ⱼ=0,1 . . . ,q−1. (6)
where for E₁└I^{s×s} 0ₛ . . . 0ₛ┘ε R^{qs×s}, V_{b,1} is an initial matrix in the Krylov subspace, and V_{b,1}=V_{b,q}E₁.

For a non-singular matrix, the system union is defined to X^{(j)}(s₀)=A^{j}R=A^{j}V_{b,1}G=V_{b,q}H_{b,q}^{j}E₁G. For j=0, . . . , q−1, X^{(j)}(s₀) relates to the matrix V_{b,q}. Thus, the reduced system may be defined to:
Â=V_{b,q}^{T}AV_{b,q}=H_{b,q}, \hat{R}=V_{b,q}^{T}R, Ĉ=CV_{b,q} (7)

For j=0, . . . ,q−1 the system union of reduced system may be corresponding to that of original system:

$$\begin{matrix}{\hat{Y}}^{( j )} ( {s}_{o} ) = \hat{C} {\hat{A}}^{j} \hat{R} \\ = C {V}_{b , q} {V}_{b , q}^{T} {A}^{j} {V}_{b , q} {V}_{b , q}^{T} R \\ = C {A}^{j} R = {Y}^{( j )} ( {s}_{o} )\end{matrix}$$

where for the property of applied matrix operation, if V^{T}V=I and V^{T}V=I then V^{T}V=I.

What is disclosed in this invention is the method of developing the analogical VLSI macro model in the global Arnoldi algorithm, in which the global Arnoldi (GA) used in this invention is provided with a model reduction skill for the reduced system formed in the MIMO system. A pseudo code for the GA algorithm (proposed at 2005 by K. Jbilou, A. J. Riquet, “Projection Methods for Large Lyapunov Matrix Equations,” Linear Algebra and its Applications, to appear) is shown below:

$Algorithm \text{:} ( input \text{:} A , R , q ; output \text{:} {V}_{q}^{g} , {H}_{q}^{g} )$
(1): /* Initialize */
${V}_{0} = R / {‖ R ‖}_{F}$
${V}_{q}^{g} = [ ] and {V}_{q}^{g} = [ {V}_{1} ]$
(2): /* Iteration */
for j = 1, 2, . . . , q

$\tilde{V} = {AV}_{j}^{g}$
for j = 1, 2, . . . , j

${h}_{i , j} = {〈 {V}_{i} , \tilde{V} 〉}_{F}$
$\tilde{V} = \tilde{V} - {H}_{i , j}^{g} {V}_{i}^{g}$

end for
${H}_{j + 1 , j}^{g} = {‖ \tilde{V} ‖}_{F}$
${V}_{j + 1}^{g} = \frac{\tilde{V}}{{h}_{j + 1 , j}}$
${V}_{q}^{g} = \begin{matrix}[ {V}_{q}^{g} & {V}_{j + 1}^{g}\end{matrix} ]$

end for

where for V_{g,1} matrix,

$${V}_{g , 1} = \frac{1}{{‖ R ‖}_{F}} R$$

is an initial matrix in the Krylov subspace. In the GA algorithm, from K_{q}(A,R)=span{R, AR, . . . , A^{q-1}R} in the Krylov subspace K_{q}(A,R)=span{R, AR, . . . , A^{q-1}R}, a Frobenius orthonormalization base V_{g,1} V_{g,2} . . . V_{g,q} is given, and the following properties are given:
For i≠j; i,j=1,2, . . . ,q, <V_{g,i}, V_{g,j}>_{F}=0 (8)
For i=j, <V_{g,i}, V_{g,j}>_{F}=1 (9)
where <.,.>_{F} is a Frobenius inner product, namely <A,B>_{F}=trace(A^{T}B)=vec(A)^{T} vec(B), in which if A=[A_{*1} A_{*2} A_{*3} . . . A_{*n}]ε R^{m×m} and A_{*j} ε R^{m}, then vec(A)=[A_{*1}^{T} A_{*2}^{T} . . . A_{*n}^{T}]^{T} ε R^{mn} and it is called vectorization of A, which is a long vectoring formed by a row vector of stack A. When the matrix of R^{m×n}, A₁,A₂, . . . ,Aₖ, is linearly independent and the matrix of R^{mn}, vec(A₁),vec(A₂), . . . , vec(Aₖ), is linearly independent, the relation between the vectorization and Kronecker product may be found in a prior are (proposed in 1985 by P. Lancaster and M Tismenetsky, The Theory of Matrices: with Applications, Academic Press, pp. 410), conclusion is made below:
vec(ABC)=(C^{T} [symbol] A)vec(B). (10)
vec(A)^{T}vec(B)=trace(A^{T}B). (11)
(A [symbol] B)(C [symbol] D)=(AC×BD). (12)
Further, a Frobenius norm is defined to ∥A,B∥_{F}=\sqrt{|trace(A^{T}B)|}=\sqrt{vec(A)^{T}vec(B)} (proposed in year 1985 by P. Lancaster and M Tismenetsky, The Theory of Matrices: with Applications, Academic Press).

From the GA algorithm, for i=1,2 . . . ,q of the matrix V_{g,j}, the interdependent property between the column vectors does not impact the algorithm. In fact, when the matrix Krylov subspace is used, the Frobenius orthonormalization base {V_{g,1}, V_{g,2}, . . . , V_{g,q}} may be given in the GA algorithm, namely, if i≠j, trace((V_{g,i})^{T}V_{g,j})=0 in the matrix Krylov subspace; each column of matrices given in the BA algorithm are orthonormal with each other, indicating that, in the space of real matrix, when the Frobenius orthonormalization base in the Krylov subspace is derived in the BA algorithm, the orthonormalization base in the block Krylov subspace of Rⁿ may be given in the BA algorithm, which is a differentia from the GA and BA algorithms.

In the GA algorithm, V_{g,q} is made to be a n×qs matrix and H_{g,q} is made to be q×q an upper Hessenberg matrix, satisfying the following relation:
AV_{g,q}=V_{g,q}(H_{g,q} [symbol] Iₛ)+h_{q+1,q}^{g}V_{g,q+1}E_{q}^{T}, (13)
where

$${H}_{g , q} = [ \begin{matrix}{h}_{11}^{g} & {h}_{12}^{g} & … & … & {h}_{1 q}^{g} \\ {h}_{21}^{g} & {h}_{22}^{g} & … & … & {h}_{2 q}^{g} \\ 0 & {h}_{32}^{g} & {h}_{33}^{g} & … & ⋮ \\ ⋮ & ⋰ & ⋰ & ⋰ & ⋮ \\ 0 & ⋯ & 0 & {h}_{q , q - 1}^{g} & {h}_{qq}^{g}\end{matrix} ] ∈ {•}^{q \times q} . ,$$

where [symbol] is the product of Kronecker, and the products of A=[aᵢⱼ]_{i,j=1}^{m}ε R^{m×m}, B=[bᵢⱼ]_{i,j=1}ⁿε R^{n×n}, and A and B Kronecker is made to be A\textcircled{×} B ε R^{mn×mn}, being defined below to:

$$A ⊗ B = [ \begin{matrix}{a}_{11} B & {a}_{12} B & … & {a}_{1 m} B \\ {a}_{21} B & {a}_{22} B & … & {a}_{2 m} B \\ ⋮ & ⋮ & ⋮ & ⋮ \\ {a}_{m 1} B & {a}_{m 2} B & … & {a}_{m m} B\end{matrix} ] = {[ {a}_{ij} B ]}_{i , j = 1}^{m}$$

V_{g,q} is made to be a matrix, being defined to V_{g,q}=[V_{g,1} V_{g,2} . . . V_{g,q}], where matrices V_{g,1}, V_{g,2}, . . . , V_{g,q} are given in the GA algorithm.

Here, a vector value function is defined to close relate to the relevant matrices and Kronecker. For the relation between the system union matrix X^{(j)}(s₀)=A^{j}R and vectorization, vec(A^{j}R)=(Iₛ [symbol] A^{j})vec(R) may be derived from equation (10), since all the matrices may be regarded as stacked vectors. The inner product is corrected at equation (11). The GA algorithm is quite similar to the standard Arnoldi algorithm, but the standard inner product is replaced by equation (11).

In the GA algorithm, in case of h_{g+1,j}^{g}=0, the algorithm stops until time j of iteration, but the same expanded subspaces may still be given. Opposite to the GA algorithm, breakdown more often occurs in the BA algorithm, which is discussed in many prior arts, and the method may be given the breakdown result better than the BA algorithm does. (proposed in year 2000 by Z. Bai, J. Demmel, J. Dongarra, A. Ruhe, H. van der Vorst, and editors, Templates for the Solution of Algebraic Eigenvalue Problems: A Practical Guide, SIAM, Philadelphia and proposed in year 1992 by Y. Saad, Numerical Methods for Large Eigenvalue Problems,” Manchester University Press).

The equation (13) may be further reduced to:
A^{j}V_{g,1}=V_{g,q}(H_{g,q}^{j}e₁ [symbol] Iₛ) (14)

For V_{g,1}=V_{g,q}E₁ and h_{q+1,q}^{g}V_{g,q+1}E_{q}^{T}E₁=0, E₁ is multiplied at the right side of equation (13) and E₁ is derived. Assuming that the equation (14) comes into existence for, in case of j=i+1,

$$\begin{matrix}{A}^{i + 1} {V}_{g , 1} = {AV}_{g , q} ( {H}_{g , q} {e}_{1} ⊗ {I}_{s} ) \\ = ( {V}_{g , q} ( {H}_{g , q} ⊗ {I}_{s} ) + {h}_{q + 1 , q}^{g} {V}_{g , q + 1} {E}_{q}^{T} ) ( {H}_{i , q} {e}_{1} ⊗ {I}_{s} ) \\ = {V}_{g , q} ( {H}_{i + 1 , q} {e}_{1} ⊗ {I}_{s} ) + {h}_{q + 1 , q}^{g} {V}_{g , q + 1} {E}_{q}^{T} ( {H}_{i , q} ⊗ {I}_{s} ) {E}_{1}\end{matrix}$$

For all the matrices Z and q≠1, then E_{q}^{T}ZE₁=0 exists.
A^{j}V_{g,1}=V_{g,q}(H_{g,q}^{j}e₁ [symbol] Iₛ), ∀ⱼ32 0,1, . . . ,q−1. (15)
To create the reduced system, the relation between the system union and the Krylov subspace is developed. In this invention, two reduced systems is analyzed, and the two reduced systems maybe given by means of congruence transformation and union matching of order q may be achieved.

In this invention, the two GA algorithms used to bring the reduced model is proposed. The first reduced system is defined to:
Â_{g,1}=V_{g,q}AV_{g,q}, \hat{R}_{g,1}=V_{g,q}R, and Ĉ_{g,1}=CV_{g,q}, (16)

where V_{g,q}⁺is a virtual inverse matrix of V_{g,q} and defined to V_{g,q}⁺=(V_{g,q}^{T}V_{g,q})⁻¹V_{g,q}^{T},

where the reduced system Â may be further reduced to:

$$\begin{matrix}{\hat{A}}_{g , 1} = {V}_{g , q}^{+} {AV}_{g , q} \\ = {V}_{g , q}^{+} ( {V}_{g , q} ( {H}_{g , q} ⊗ {I}_{s} ) + {h}_{q + 1 , q}^{g} {V}_{g , q + 1} {E}_{q}^{T} ) \\ = ( {H}_{g , q} ⊗ {I}_{s} ) + {V}_{g , q}^{+} Δ {V}_{g , q}\end{matrix}$$

where Δ is defined to Δ=h_{q+1,q}^{g}V_{g,q+1}E_{q}^{T}V_{g,q}⁺. Also, \hat{R} may be reduced to:
\hat{R}_{g,1}=V_{g,q}⁺R=V_{g,q}⁺∥R∥_{F}V_{g,q}(e₁ [symbol] Iₛ)=∥R∥_{F} (e₁Iₛ)

By means of the reduction technology developed in the GA algorithm, the property of union may be achieved.

In case of j=0,1, . . . , q−1, the output union Ŷ^{(j)}(s₀) of reduced system that is given in the global Arnoldi algorithm is equal to the Y^{(j)}(s₀) union output of original MNA system in equation (2), namely

$$\begin{matrix}{\hat{Y}}^{( j )} ( {s}_{0} ) = {{C}^{̑}}_{g , 1} {\hat{A}}_{g , 1}^{j} {\hat{R}}_{g , 1} \\ = {CV}_{g , q} {V}_{g , q}^{+} {A}^{j} {V}_{g , q} {V}_{g , q}^{+} R \\ = {CA}^{j} R \\ = {Y}^{( j )} ( {s}_{0} )\end{matrix}$$

Provided in a prior art (proposed in year 2004 by K. Gallivan, A. Vandendorpe and P. Van Dooren, [symbol] §Sylvester Equations and Projection-based. Model Reduction, [symbol] ” J. Computational and Applied Mathematics, Vol. 162, pp. 213-229), the reduction transformation matrix is defined to Ĥ(s), and Ĥ(s), Ĥ(s) and Ĥ(s). If projection V and Z is replaced with other matrices \hat{V}=VR and \hat{Z}=ZL in a space similarly expanded and R and L may be oppositely transformable, the projection transformation matrix is not changed.

Thus, it is identical, proving that, if the system union is expressed as {X⁰(s₀),X¹(s₀), . . . X^{q-1}(s₀)}, the transformation matrix of reduced system is given in the BA algorithm and that is given in the GA algorithm. According to the equation (9), the system union given in the BA algorithm may be expressed as:

$$[ {E}_{1} {V}_{b , q} {E}_{1} {V}_{b , q} {H}_{b , q} {E}_{1} … {V}_{b , q} {H}_{b , q}^{q - 1} ] = {V}_{b , q} [ {E}_{1} {H}_{b , q} {E}_{1} … {( {H}_{b , q} )}^{q - 1} {E}_{1} ] = {V}_{b , q} {ℜ}^{b}$$

H_{b,q} is an upper Hessenberg matrix, so [symbol] is an triangle matrix on a block.

On the other hand, according to the equation (15), the system union given in the GA algorithm may be expressed as:

$$[ {V}_{g , q} {E}_{1} {V}_{g , q} ( {H}_{g , q} ⊗ {I}_{s} ) {E}_{1} … {V}_{g , q} ( {H}_{g , g}^{q - 1} ⊗ {I}_{s} ) {E}_{1} ] = {V}_{g , q} [ {E}_{1} ( {H}_{g , q} ⊗ {I}_{s} ) {E}_{1} … ( {( {H}_{g , q} )}^{q - 1} ⊗ {I}_{s} ) {E}_{1} ] = {V}_{g , q} {ℜ}^{g}$$

where [symbol] is also an upper triangle matrix, since

$$colsp [ {X}^{0} ( {s}_{0} ) , {X}^{1} ( {s}_{0} ) , … {X}^{q - 1} ( {s}_{0} ) ] = colsp ( {V}_{b , q} ) = colsp ( {V}_{g , q} ) \cdot {V}_{b , q} = {V}_{g , q} {{ℜ}^{g} ( {ℜ}^{b} )}^{- 1} , {{ℜ}^{g} ( {ℜ}^{b} )}^{- 1}$$

is an triangle matrix and non-singular. Thus, it proves that the two transfer matrix are the same.

An transfer matrix error between the original MNA and reduced systems is not easily analyzed and given, so for the conventional SISO system, the prior art here gives the difference of the two systems from the conception of a residual error (proposed in year 2005 by C. C. Chu, H. J. Lee and W. S. Feng, “Error Estimations of Arnoldi-Based Interconnect Model-Order Reductions,” IEICE Trans. Fundamentals, Vol. E88-A, No. 2, pp. 533-537). From the definition of MIMO system in this invention, the residual error Eᵣ(s) is
Eᵣ(s)=(Iₙ−sA)\tilde{X}(s)−R (17)

where \tilde{X}(s) is an approximate solution to \tilde{X}(s). If \tilde{X}(s)=X(s), then \tilde{X}(s)=X(s). In the BA algorithm or the GA algorithm, the approximate solution \tilde{X}(s) must belong to the Krylov subspace, namely \tilde{X}(s)=V_{g,q}\tilde{X}(s) or V_{b,q}\hat{X}(s).

If the GA algorithm executes q times of iteration, a Frobenius orthonormalization matrix V_{g,q} and a corresponding upper Hessenberg matrix H_{g,q} may be given. \tilde{X}(s) is made to be an approximate solution to X(s), while \tilde{X}(s) is made to be that after q times of the iteration operation in the Arnoldi algorithm, namely X(s)=V_{g,q}\hat{X}(s), in which Eᵣ(s) is a residual error. The calculation of residual error Eᵣ(s) is shown as follows.

Because of \tilde{X}(s) ε κ_{q}(A,R), \tilde{X}(s) may be expressed as the linear combination of column vector V_{g,q}, namely \tilde{X}(s)=V_{g,q}\hat{X}(s). The residual error may be given from the following operation:

$$\begin{matrix}{E}_{r} ( s ) = ( {I}_{n} - sA ) {V}_{g , q} \hat{X} ( s ) - R \\ = ( {V}_{g , q} - {sAV}_{g , q} ) {( {I}_{qs} - s ( {H}_{g , q} ⊗ {I}_{s} ) )}^{- 1} {V}_{g , q}^{+} R - R \\ = ( \begin{matrix}{V}_{g , q} ( {I}_{qs} - s ( {H}_{g , q} ⊗ {I}_{s} ) ) - \\ {sh}_{q + 1 , q}^{g} {V}_{g , q + 1} {E}_{q}^{T}\end{matrix} ) {( {I}_{qs} - s ( {H}_{g , q} ⊗ {I}_{s} ) )}^{- 1} {( {V}_{g , q} )}^{+} R - R\end{matrix} \qquad ( 18 )$$

R belongs to the expanded subspace of V_{g,q}, so V_{g,q}(V_{g,q})⁺R=R proves. Through the simple algebra operation, the above equation may be changed into:
Eᵣ(s)=−sh_{q+1,q}^{g}V_{g,q+1}E_{q}^{T}(I_{qs}−s(H_{g,q} [symbol] Iₛ))⁻¹(V_{g,q})⁺R (19)

An error range may be estimated from the following means. Assuming that all the properties of H_{g,q} are very simple and (H_{g,q} [symbol] Iₛ)=S_{qs}Λ_{qs}S_{qs}⁻¹ is the property value resolution of (H_{g,q} [symbol] Iₛ), the equation (19) being reduced to:

$$\begin{matrix}{E}_{r} ( s ) = - {sh}_{q + 1 , q}^{g} {V}_{g , q + 1} {E}_{q}^{T} {{S}_{qs} ( {I}_{qs} - s {Λ}_{q} )}^{- 1} {S}_{qs}^{- 1} {V}_{g , q}^{+} R \\ = {sh}_{q + 1 , q}^{g} {V}_{g , q + 1} {E}_{q}^{T} {S}_{qs} Z ( s ) {S}_{qs}^{- 1} {V}_{g , q}^{+} R\end{matrix} \qquad ( 20 )$$

where

$$Z ( s ) = {diag [ \frac{s}{1 - s {λ}_{i}} ]}^{qs} . ,$$

since Z(s) is a high-pass matrix,

$${‖ Z ( s ) ‖}_{∞} = {min}_{i = 1}^{qs} \frac{1}{\vert {λ}_{i} \vert} .$$

After a norm L_{∞} is employed from the two sides of equation (20), the following equation is given:
∥E(s)∥_{∞}≦κ(S_{qs})|h_{q+1,q}^{g}|∥(V_{q}^{g})⁺∥∥R∥₂ (21)

where κ(·) is the status number of matrix. From the above error estimation, only κ(S_{qs}), V_{qs}⁺ R, and h_{q+1,q}^{g} are included. Compared with the representation of error in prior art (proposed in year 1999 by A. Odabasioglu, M. Celik and L. T. Pileggi, practical Considerations for Passive Reduction of RLC Circuits, [symbol] ” Proc. ICCAD, pp. 214-219), the suggested formula is involved in less calculation. Since it wastes time in κ(S_{qs}) calculation, only h_{q+1,q} may be considered among candidate systems. Instead of an absolute value, a relative value

$${μ}_{q} = ‖ \frac{{h}_{q , q - 1}^{g}}{{h}_{q + 1 , q}^{g}} ‖$$

is used to serve the basis of iteration process termination. If μ_{q} is quite small, then the original system and the reduced system are almost equal.

From the second reduced system according to this invention, in comparison of the given system given in the BA algorithm (10) with that given in the GA algorithm (18), it is apparent that the reduced system Â is similar; except the term, related to Δ, added in the GA algorithm, the column vector of matrix V_{g,q} does not need interdependent orthonormalization. To keep the simple formula of matrix Â in the BA algorithm, the second reduced system is here defined to:
Â_{g,2}=V_{g,q}⁺(A−Δ)V_{g,q} (22)

where Δ=h_{q+1,q}^{g}V_{g,q+1}E_{q}^{T}V_{g,q}. From the equation (12), it is known that the reduced Â may be further reduced to:
Â_{g,2}=H_{q} [symbol] Iₛ

where in case of i=0,1, . . . ,q−1, the union matching property still exists.

$$\begin{matrix}{{C}^{̑}}_{g , 2} {{A}^{̑}}_{g , 2}^{i} {{R}^{̑}}_{g , 2} = {{CV}_{g , q} ( {H}_{g , q} ⊗ {I}_{s} )}^{i} {‖ R ‖}_{F} ( {e}_{1} ⊗ {I}_{s} ) \\ = {CV}_{g , q} ( {H}_{g , q}^{i} {e}_{1} ⊗ {I}_{s} ) {‖ R ‖}_{F} \\ = {CA}^{i} {V}_{g , 1} {‖ R ‖}_{F} \\ = {CA}^{i} R\end{matrix} \qquad ( 23 )$$

Thus, the transfer matrix of reduced system may be changed into:
Ĥ_{g,2}(s₀+σ)=Ĉ_{g,2}(I_{q}−σÂ_{g,2})⁻¹\hat{R}_{g,2} (24)

Next, an equation of the status of a perturbation system that is defined in this invention is:

$$A \frac{ⅆ {x}_{Δ} ( t )}{ⅆ t} = {x}_{Δ} ( t ) + Ru ( t ) and y ( t ) = {Cx}_{Δ} ( t ) \qquad ( 25 )$$

The transfer matrix of perturbation system is made to be H_{Δ}(s) The transfer matrix of reduced system defined in the equation (22) is actually equal to the transfer matrix of original MNA provided with perturbation system defined in the equation (25), namely Ĥ_{g,2}(s₀+σ)=H_{Δ}(s₀+σ).

Since Â_{g,2}=V_{g,q}⁺(A−Δ)V_{g,q} may be changed into (A−Δ)V_{g,q}=V_{g,q}Â_{g,2}, −σ is multiplied and then plus V_{q} at the two sides of equation, thereby the equation being changed into:
V_{g,q}(I_{qs}−σÂ_{g,2})⁻¹=(I−σ(A−Δ))⁻¹V_{g,q}

Finally, C is multiplied at the left side of equation and C is multiplied at the right side of equation, and then the result is:
CV_{g,q}(I_{qs}−σÂ)⁻¹∥R∥_{F}(e₁ [symbol] Iₛ)=C(Iₙ−σ(A−Δ))⁻¹V_{g,q}∥R∥_{F}(e₁ [symbol] Iₛ) (26)

Since Ĉ_{g,2}=CV_{g,q}, Ĉ_{g,2}=CV_{g,q}, and Ĉ_{g,2=CV}_{g,q}, the equation (26) may be changed into:
Ĉ_{g,2}(I_{qs}−σÂ_{g,2})⁻¹\hat{R}_{g,2}=C(Iₙ−σ(A−Δ))⁻¹R

The transfer matrix H_{Δ}(S₀+σ) of perturbation system defined in the equation (25) is actually equal to the transfer matrix Ĥ_{g,2}(s₀+σ) of reduced system defined in the equation (22), namely Ĥ_{g,2}(s₀+σ)=H_{Δ}(s₀+σ).

Δ may be regarded as s of the rank of original matrix, and such perturbation shows the reason of the dynamic action of reduced system that is quite approximate to that of original system MNA. It meanwhile reflects the result of some restriction on the reduced system when circuits are interconnected. Since Δ comprises

$${h}_{q + 1 , q}^{g} , {μ}_{q} = ‖ \frac{{h}_{q , q - 1}^{g}}{{h}_{q + 1 , q}^{g}} ‖$$

may serves as the basis of GA iteration process termination.

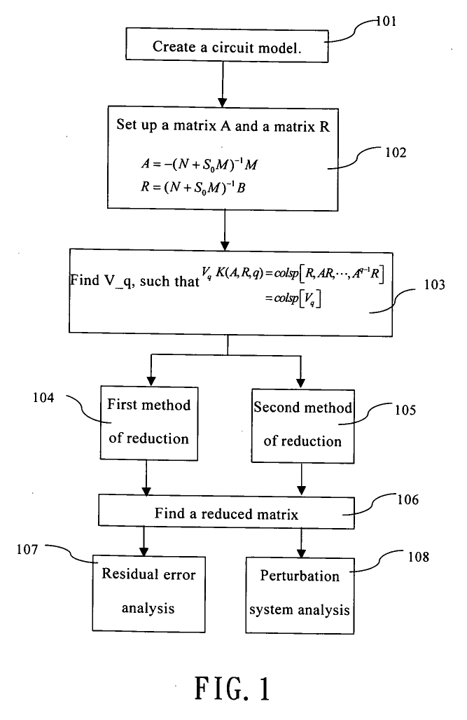

As shown in FIG. 1, a flow chart is used in this invention to describe the whole process of model reduction.

At step 101, a nodal analysis equation for an original circuit is inputted to create a circuit model equation (1).

At step 102, A=−(N+s₀M)⁻¹M and R=(N+s₀M)⁻¹B are set.

At step 103, an orthonormalization base K(A, R, q)=colsp[R, AR, . . . , A^{q-1}R]=colsp[V_{r,q}] in the Krylov subspace is found, and in the GA algorithm, a projection matrix V_{g,q} may be given; next, the projection is used in this invention to create a reduced system.

At step 104, a first method of reduction is used to find a reduced matrix at step 106.

At step 105, a second reduced system is provided to find the reduced system provided at step 106 in a method of recursion.

At step 107, a residual error of the reduced system is deduced, and transfer functions of the reduced systems in a global Arnoldi algorithm and in a regional Arnoldi algorithm may be verified to be identical to each other.

At step 108, a math model for a perturbation system is deduced, and the transfer function of reduced matrix and that of original system additionally provided with the perturbation system is verified to be corresponding to each other.

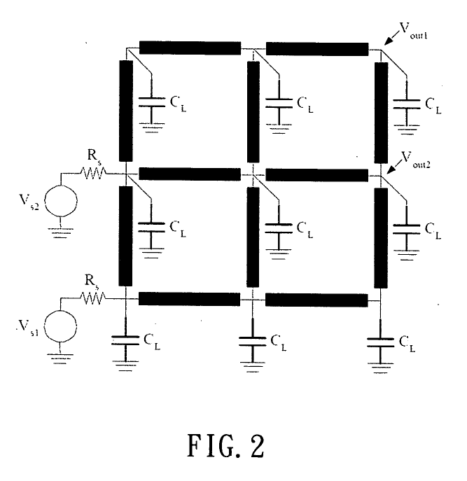

Again, a simple embodiment is used for test to verify the accuracy of algorithm according to this invention. In FIG. 2, an RLC circuit with 12 lines is provided. Line parameters are a resistor of 1.0 Ω/cm, a capacitor of 5.0 pF/cm, an inductor of 1.5 nH/cm, a drive resistor of 3Ω, and a load capacitor of 1.0 pF, respectively. Each line is 30 mm long and divided into 30 mm pieces. Thus, for the dimension of MNA matrix, n=1198 In the embodiment, a frequency range lower than {0,15 GH_{z}} is used and the expanded frequency of a reduced system is {0,15 GH_{z}}. When the GA algorithm starts, the values h_{q+1,q} and h_{q+1,q} are recorded.

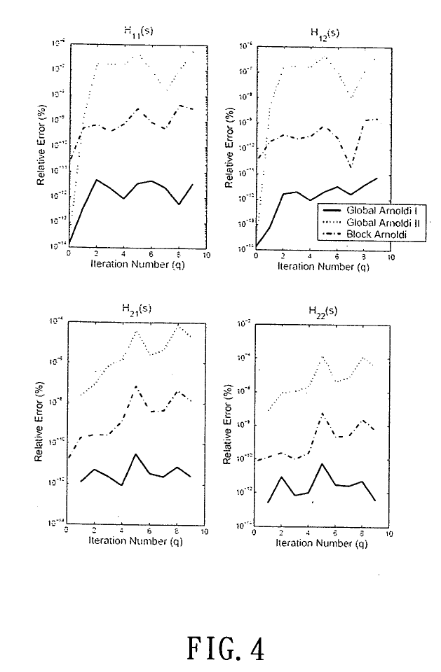

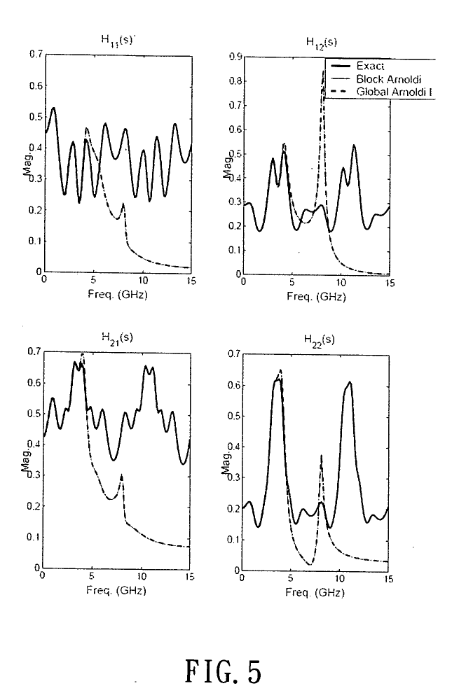

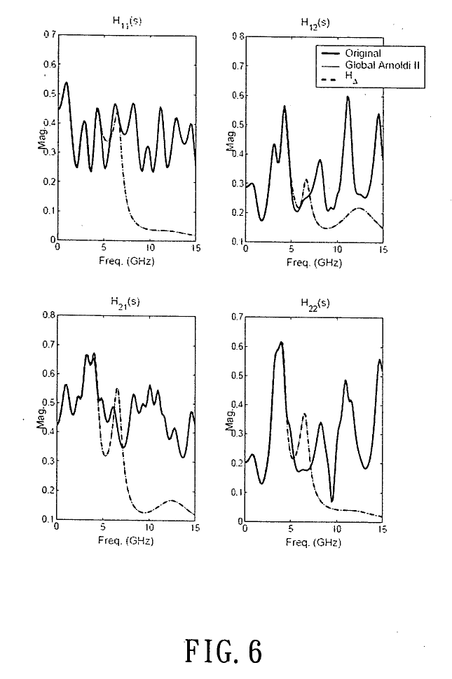

In FIG. 5 showing the concluded results of simulation, it is observed that μ_{q} becomes small when 12 times of iteration reach, and thus 12 is the recommended order setting of the reduced system, thereby the order of reduced system being qs=24. In the method of model reduction provided in this invention, the relevant error of system union before q order(s) for the original system compared with the three reduced systems Ĥ_{g,1}(s), Ĥ_{g,2}(s), and Ĥ_{b,q}(s) in FIG. 4, in which the system union of first reduced model in the Global Arnoldi algorithm is apparent, is accurate, compared with the reduced model generated in the conventional Block Arnoldi algorithm. However, the system union of the three reduced systems are identical to the original system. Also, Hᵢⱼ(s) indicates the impact of an input source i on a receiving end of output J. FIG. 5 shows transfer matrices of original system H(s) and two reduced systems H(s) and H(s). In the figure, it is observed that the transfer matrix of reduced system and the transfer matrix of original system are corresponding at a frequency expansion point, and that the frequency response of two reduced systems are completely corresponding to each other, and thus frequency response curves fully overlap in the whole simulation frequency domain. Further, FIG. 6 shows the frequency response H(s) of original system, the frequency response Ĥ_{g,2}(s) of second reduced system in the Global Arnoldi algorithm, and the frequency response H_{Δ}(s) of original system additionally provided with the perturbation system, in which the frequency response Ĥ_{g,2}(s) and H_{Δ}(s) is corresponding to the original system near the frequency expansion point; also, from the result of frequency response simulation, it is verified that the two are corresponding and the overlap of response curves proves that high accuracy achieves.

This invention gives a method of reducing the model in the MIMO interconnect circuit system, in which the operation complexity of simulation and analysis on the interconnect circuit may be reduced in the global Arnoldi algorithm. From the two reduced model system according to this invention, it is verified that the system union of the preceding q orders is completely corresponding to the original system. It is verified that the output transfer function of the first reduced system is completely corresponding to the reduced system in the block Arnoldi algorithm. Besides, this invention provides the residual error that may serve as a reference material for determination of the reduced model order. Next, from the second reduced system according to this invention, the math model of perturbation system may be derived, in which it is verified that the output transfer function of second reduced system is corresponding to the transfer function of original system additionally provided with the perturbation system in height.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. Method of developing an analogical VLSI macro model in a global Arnoldi algorithm, comprising:
step 1 to input a net-shaped circuit;
step 2 to input a frequency expansion point;
step 3 to build up a state-space matrix for a circuit;
step 4 to generate a projection matrix by way of a global Arnoldi algorithm;
step 5 to determine a reduced model order by an iteration termination condition, and to execute a first model reduction; and
step 6 to build up a mathematics model for a perturbation system and to execute a second model reduction.

2. The method of developing an analogical VLSI macro model in a global Arnoldi algorithm according to claim 1, wherein from the iteration termination condition described at step 5, a residual error for a first reduced system and an original system may be defined to:
Eᵣ(s)=s(V_{g,q}V_{g,q}⁺−Iₙ)h_{q+1,q}^{g}V_{g,q+1}E_{q}^{T}(I_{qs}−s(H_{g,q} [symbol] Iₛ)−sV_{g,q}⁺ΔV_{g,q})⁻¹V_{g,q}R∥Eᵣ(s)∥_{∞}≦κ(S_{qs})∥V_{g,q}V_{g,q}⁺−Iₙ∥₂|h_{q+1,q}^{g}|∥V_{g,q}⁺∥ ∥R∥₂
where a norm ∥E(s)∥_{∞}≦κ(S_{qs})|h_{q+1,q}^{g}|∥(V_{q}^{g})⁺∥∥R∥₂ is derived from Eᵣ(s), a value in the iteration process h_{q+1,q}^{q} may technically serves to evaluate the reduced model order, and thus an order q is determined to satisfy
$${μ}_{q} = ‖ \frac{{h}_{q , q - 1}^{g}}{{h}_{q + 1 , q}^{g}} ‖ < ɛ ,$$
in which ε is a permissible error that is small enough.

3. The method of developing an analogical VLSI macro model in a global Arnoldi algorithm according to claim 1, wherein for the second model reduction described at step 6, the perturbation system is added to serve as the perturbation of additive property for the transfer function H(s) of original circuit, and the transfer function H(s) of a corrective nodal analysis may be indicated below as:
$$A \frac{ⅆ {x}_{Δ} ( t )}{ⅆ t} = {x}_{Δ} ( t ) + Ru ( t ) and y ( t ) = {Cx}_{Δ} ( t )$$
where Δ=h_{q+1,q}^{g}V_{g,q+1}E_{q}^{T}V_{g,q} and q are reduced model orders in a global Arnoldi algorithm, h_{q+1,q}^{g} and V_{g,q+1} may be given in the process of operation of the reduced system, V_{g,q}⁺ is a virtual inverse matrix of a projection matrix V_{g,q}, and thus a transfer function H_{Δ}(S) of perturbation system is equal to a transfer function Ĥ(s) of the system after reduced.
